(19) United States
(12) Patent Application Publication
(10) Pub. No.: US 2023/0347921 A1
(43) Pub. Date: Nov. 2, 2023

(54) VEHICLE DISPLAY CONTROL SYSTEM, COMPUTER-READABLE MEDIUM, VEHICLE DISPLAY CONTROL METHOD, AND VEHICLE DISPLAY CONTROL DEVICE

(71) Applicant: Panasonic Intellectual Property Management Co., Ltd., Osaka (JP)

(72) Inventor: Daisuke IWAHASHI, Osaka (JP)

(21) Appl. No.: 18/165,231

(22) Filed: Feb. 6, 2023

(30) Foreign Application Priority Data
Mar. 31, 2022 (JP) 2022-059180

(51) Int. Cl. B60W 50/14; B60W 50/08; B60W 40/02; B60W 50/06; B60K 35/00; B60W 60/00; G06T 11/00

(52) U.S. Cl. CPC B60W 50/14; B60K 35/00; B60W 40/02; B60W 50/06; B60W 50/082; B60W 60/005; G06T 11/00; B60K 2370/52; B60W 2050/143; B60W 2050/146; B60W 2420/00; B60W 2554/80

(57) ABSTRACT

A vehicle display control system according to the present disclosure includes an obstacle sensor, an environmental factor sensor, a memory, and a hardware processor coupled to the memory. The obstacle sensor detects an obstacle around a vehicle. The environmental factor sensor detects an environmental factor that changes a detection range of the obstacle sensor with respect to the obstacle. The hardware processor is configured to: control a display device that converts a detection indication region falling within the detection range of the obstacle sensor with respect to the obstacle, into a detection indication image representing the detection indication region from a viewpoint of a driver of the vehicle, and superimposes and displays the detection indication image on a scene around the vehicle; correct the detection range in accordance with the environmental factor; and update the detection indication region in accordance with the detection range that has been corrected.

### CROSS-REFERENCE TO RELATED APPLICATIONS

This application is based upon and claims the benefit of priority from Japanese Patent Application No. 2022-059180, filed on Mar. 31, 2022, the entire contents of which are incorporated herein by reference.

### FIELD

The present disclosure relates to a vehicle display control system, a computer-readable medium, a vehicle display control method, and a vehicle display control device.

### BACKGROUND

In order to improve a sense of security of a driver, a technique of projecting a detection indication region on a display device such as a head up display (HUD) (see Japanese Patent No. 6252316) has been developed. The detection indication region indicates to what extent a range is to be detected by an obstacle sensor. The detection indication region is expanded or reduced within a range not exceeding the detection range of the obstacle sensor.

### SUMMARY

However, there are ways to improve the above-stated technique according to Japanese Patent No. 6252316.

In view of this, the present disclosure provides a vehicle display control system, a computer-readable medium, a vehicle display control method, and a vehicle display control device with which further improvements can be made.

A vehicle display control system according to the present disclosure includes an obstacle sensor, an environmental factor sensor, a memory, and a hardware processor coupled to the memory. The obstacle sensor detects an obstacle around a vehicle. The environmental factor sensor detects an environmental factor that changes a detection range of the obstacle sensor with respect to the obstacle. The hardware processor is configured to: control a display device that converts a detection indication region falling within the detection range of the obstacle sensor with respect to the obstacle, into a detection indication image representing the detection indication region from a viewpoint of a driver of the vehicle, and superimposes and displays the detection indication image on a scene around the vehicle; correct the detection range in accordance with the environmental factor; and update the detection indication region in accordance with the detection range that has been corrected.

### BRIEF DESCRIPTION OF THE DRAWINGS

FIG. 1 is a block diagram illustrating one example of a schematic configuration of a driving assistance system 100 in a first embodiment;

FIG. 2A is a schematic diagram illustrating one example of a detection range of an obstacle sensor group 2;

FIG. 2B illustrates one example of processing of correcting the detection range of the obstacle sensor group 2;

FIG. 3 is a block diagram illustrating one example of a schematic configuration of an HCU 1 in the first embodiment;

FIG. 4 is a schematic diagram illustrating a detection indication region;

FIG. 5 is a schematic diagram illustrating selection of the detection indication region;

FIG. 6 is a flowchart illustrating one example of a flow of display control-related processing in the HCU 1;

FIG. 7 is a schematic diagram illustrating one example of a setting of an obstacle notification region;

FIG. 8 is a schematic diagram illustrating a setting of a distance of an arc-shaped ripple;

FIG. 9 is a schematic diagram illustrating a setting for displaying an arc-shaped ripple such that the ripple appears to move in the ripple spreading direction;

FIG. 10A is a schematic diagram illustrating a range cut out from the detection indication region for projection conversion;

FIG. 10B illustrates one example of processing of displaying a detection indication image;

FIG. 11 is a schematic diagram illustrating a display mode of the detection indication image projected on a windshield;

FIG. 12 is a schematic diagram illustrating the display mode of the detection indication image projected on the windshield;

FIG. 13 is a schematic diagram illustrating the display mode of the detection indication image projected on the windshield;

FIG. 14 is a schematic diagram illustrating a display mode of an obstacle notification image projected on the windshield;

FIG. 15 is a block diagram illustrating one example of a schematic configuration of a driving assistance system 200 in a first variation;

FIG. 16 is a block diagram illustrating one example of a schematic configuration of an HCU 1a in the first variation;

FIG. 17 illustrates one example of display of an icon image for warning about running into an obstacle; and

FIG. 18 illustrates one example of display of an image projected on the windshield in a case where obstacles are frequently detected in a certain direction.

### DETAILED DESCRIPTION

### Underlying Knowledge Forming Basis of the Present Disclosure

The inventors of the present application found that the technique according to Japanese Patent No. 6252316 stated in the “Background” section have problems as below.

Although a detection range of an obstacle sensor changes due to environmental factors (e.g., weather and temperature), Japanese Patent No. 6252316 does not disclose a technique of correcting a detection range at the time when the detection range of the obstacle sensor changes due to the environmental factors. Therefore, in the technique described in Japanese Patent No. 6252316, the detection indication region is not updated when the detection range of the obstacle sensor is narrowed by the environmental factors. Even when an obstacle is in the detection indication region, the obstacle sensor may detect no obstacles. This situation may increase anxiety of the driver.

The present disclosure provides a vehicle display control system, a computer-readable medium, a vehicle display control method, and a vehicle display control device capable of reducing anxiety of a driver.

Hereinafter, an embodiment of a vehicle display control system, a program, a vehicle display control method, and a vehicle display control device according to the present disclosure will be described with reference to the drawings. The following embodiment is applied to a region where lefthand traffic is legislated. Right and left of the following embodiment are reversed in a region where right-hand traffic is legislated.

### First Embodiment

### Schematic Configuration of Driving Assistance System 100

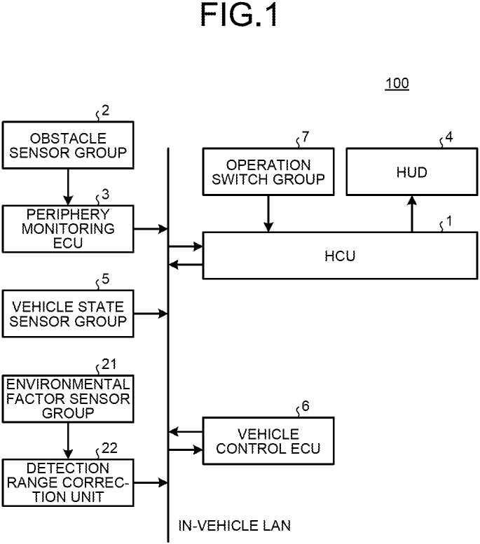

FIG. 1 illustrates one example of a schematic configuration of a driving assistance system 100 to which a vehicle display control device according to the present invention is applied. As illustrated in FIG. 1, the driving assistance system 100 functions as a vehicle display control system, and includes a human machine interface control unit (HCU) 1, an obstacle sensor group 2, a periphery monitoring ECU 3, a head-up display (HUD) 4, a vehicle state sensor group 5, a vehicle control ECU 6, an operation switch group 7, an environmental factor sensor group 21, and a detection range correction unit 22. For example, the HCU 1, the periphery monitoring ECU 3, the vehicle state sensor group 5, and the vehicle control ECU 6 are connected via an in-vehicle LAN. A vehicle mounted with the driving assistance system 100 is hereinafter referred to as an own vehicle.

The obstacle sensor group 2 includes various obstacle sensors that are mounted on the own vehicle and that detect an obstacle around the own vehicle. The obstacle sensor group 2 includes obstacle sensors such as a millimeter wave radar, a laser radar, a sonar, and a camera. Although, in the present embodiment, the obstacle sensor group 2 is mounted on the own vehicle, this is not a limitation. The obstacle sensor group 2 may be provided outside the vehicle. For example, the obstacle sensor group 2 may include a sensor (e.g., monitoring camera) provided on an infrastructure side. In this case, the driving assistance system 100 receives a detection result of an obstacle from a sensor provided on the infrastructure side or the like.

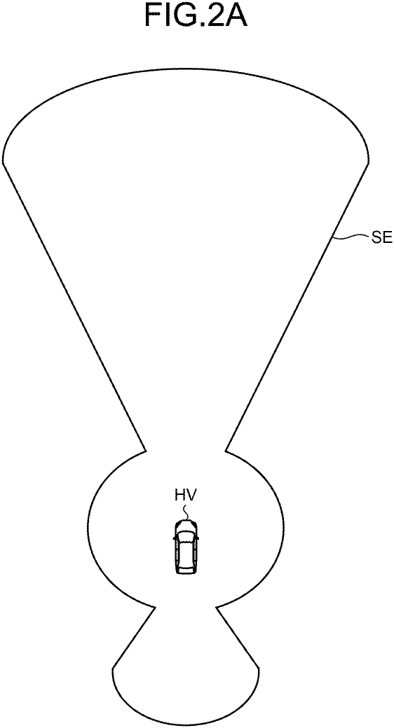

Here, a detection range of the obstacle sensor group 2 will be described with reference to FIG. 2A. FIG. 2A illustrates one example of the detection range of the obstacle sensor group 2. HV represents the own vehicle. SE represents the detection range of the obstacle sensor group 2. The same applies to the subsequent drawings. The obstacle sensor group 2 sets all directions around the own vehicle as the detection range as illustrated in FIG. 2A by combining a plurality of sensors having different detection ranges, for example.

The periphery monitoring ECU 3 controls actuation of the obstacle sensor group 2. Furthermore, the periphery monitoring ECU 3 detects an obstacle around the own vehicle and detects a relative position and a relative speed of the obstacle with respect to the own vehicle based on a signal from the obstacle sensor group 2. Then, the detected relative position and relative speed are sequentially output to the HCU 1.

For example, when the obstacle sensor group 2 includes a millimeter wave radar, a laser radar, and a sonar, an obstacle is detected based on reception of a reflected wave of a probing wave. Furthermore, the orientation of the obstacle with respect to the own vehicle is detected based on a direction of transmission of the probing wave of which the reflected wave has been received. The distance from the own vehicle to the obstacle is detected based on the time from transmission of the probing wave to reception of the reflected wave. When the obstacle sensor group 2 is a radar, a phase monopulse radar may be used to detect the relative position with respect to the own vehicle. The relative speed may be detected by a known method based on Doppler shift between the probing wave and the reflected wave.

When the obstacle sensor group 2 includes a camera, an obstacle is detected by a known image recognition technique. Furthermore, when a camera installation position and an optical axis orientation with respect to the own vehicle are determined, the orientation and distance (i.e., relative position) to the own vehicle can be detected based on the position in a captured image, so that the relative position of the obstacle to the own vehicle is detected based on the camera installation position and an optical axis orientation with respect to the own vehicle and the position of the obstacle in the captured image. When the obstacle sensor group 2 includes a stereo camera, the distance of the obstacle to the own vehicle may be detected based on an amount of the parallax between a pair of cameras. Regarding the relative speed, the relative speed may be detected based on a change in the size of the obstacle in sequentially captured images.

The HUD 4 is a head-up display device that displays a virtual image of a display image on a TFT liquid crystal panel in a manner in which the virtual image can be visually recognized from the interior of the own vehicle by projecting the display image on a windshield of the own vehicle. This virtual image displayed by the HUD 4 is visually recognized by a driver with the virtual image overlapping the scenery in front of the vehicle. That is, the HUD 4 superimposes and displays an image on a scene visible to the driver of the own vehicle through the windshield of the own vehicle. Hereinafter, the display image projected on the windshield by the HUD 4 is referred to as an HUD image. Note that the HUD 4 is not limited to having a configuration using the TFT liquid crystal panel as a display element, and may have a configuration using a laser element.

A projection surface on the windshield on which the HUD image is projected is located below a driving view field region to be secured at the time when the driver performs driving operation in order to decrease an amount of movement of a line-of-sight of the driver and reduce a focus adjustment load.

The vehicle state sensor group 5 includes various sensors that detect the state of the own vehicle, and includes, for example, a vehicle speed sensor, an acceleration sensor, a yaw rate sensor, a receiver used in a satellite positioning system, and a steering angle sensor. The vehicle speed sensor detects the speed of the own vehicle. The acceleration sensor detects an acceleration acting on the own vehicle. The yaw rate sensor detects an angular velocity (i.e., yaw rate) around a vertical axis of the own vehicle. The receiver used in the satellite positioning system acquires data indicating a current position by receiving a radio wave from a positioning satellite. The steering angle sensor detects a steering angle of the own vehicle.

The vehicle control ECU 6 causes an EPS_ECU (not illustrated) to automatically perform steering control or causes an engine ECU (not illustrated) and a brake ECU (not illustrated) to automatically perform acceleration/deceleration control based on information input from the periphery monitoring ECU 3 and the vehicle state sensor group 5. The EPS_ECU controls a steering angle by operating an EPS actuator. The engine ECU controls acceleration by operating a throttle actuator. The brake ECU controls deceleration by operating a brake actuator.

Examples of automatic acceleration/deceleration control include known follow-up traveling control in which the acceleration/deceleration control is automatically performed such that the inter-vehicle distance between the own vehicle and a preceding vehicle among obstacles detected by the periphery monitoring ECU 3 corresponds to an aimed inter-vehicle distance. Examples of the automatic steering control include lane keeping control in which steering control is automatically performed to maintain a traveling lane. When the lane keeping control is performed, the obstacle sensor group 2 includes a camera for imaging a road surface in front of the own vehicle. Hereinafter, traveling of the own vehicle with the follow-up traveling control and the lane keeping control being performed will be referred to as automatic driving. Note that the automatic driving can also be referred to as semi-automatic driving.

The operation switch group 7 includes, for example, a mechanical switch provided around a steering. The operation switch group 7 is operated by the driver to switch the start/end of the automatic driving and to make various settings.

The environmental factor sensor group 21 includes an environmental factor sensor that detect an environmental factor that changes the detection range of the obstacle sensor group 2. For example, the environmental factor sensor group 21 may include sensors such as a temperature sensor, a solar radiation sensor, and a raindrop sensor, or may include a device that acquires data with an image sensor, a light detection and ranging (LiDAR), and the like, and that further identifies an environmental factor by performing post-processing on the data. Here, the environmental factor includes a disturbance that changes the detection range or detection accuracy of the obstacle sensor group 2. The disturbance of the environmental factor may include at least one of rain (rainfall: X mm), snow, fog, temperature, and sunlight.

The detection range correction unit 22 corrects the detection range of the obstacle sensor group 2 in accordance with an environmental factor detected by the environmental factor sensor group 21. In the present embodiment, when the detected environmental factor includes a disturbance, the detection range correction unit 22 narrows the detection range of the obstacle sensor group 2 as the disturbance increases. FIG. 2B illustrates one example of processing of correcting the detection range of the obstacle sensor group. For example, when a rainfall increases from 0 to X (mm), the detection range correction unit 22 narrows the detection range of the obstacle sensor group 2 as illustrated in FIG. 2B. The rainfall is one example of the disturbance detected by the environmental factor sensor group 21.

Furthermore, the detection range correction unit 22 can also change the correction of the detection range of the obstacle sensor group 2 in accordance with the type of the obstacle sensor group 2. For example, when the obstacle sensor of the obstacle sensor group is an image sensor (camera), the image sensor is characterized by being vulnerable to bad weather (e.g., rain, snow, and fog). Therefore, for example, when the rainfall detected by the environmental factor sensor group 21 as an environmental factor is a rainfall X (mm) or more, the detection range correction unit 22 may narrow the detection range of the obstacle sensor group 2 to a detection range narrower than a preset detection range.

Furthermore, for example, when the obstacle sensor of the obstacle sensor group 2 is a sonar, the sonar is characterized by having low reliability in a case where the periphery of the sonar has high or low temperature. Therefore, for example, when the temperature around the obstacle sensor group 2 detected by the environmental factor sensor group 21 is equal to or more than a temperature X2 around a sensor, the detection range correction unit 22 may narrow the detection range of the obstacle sensor group 2 to a detection range Y2 narrower than a preset detection range.

Although, in the present embodiment, the detection range correction unit 22 is provided outside the HCU 1, the detection range correction unit 22 may be provided inside the HCU 1. Furthermore, although, in the present embodiment, the detection range correction unit 22 acquires an environmental factor from the environmental factor sensor group 21, this is not a limitation. For example, the detection range correction unit 22 may, from the periphery monitoring ECU 3, acquire an environmental factor detected by a sensor connected to the periphery monitoring ECU 3.

The HCU 1 is mainly configured as a microcomputer, and includes a CPU, a memory such as a ROM, a RAM, and an EEPROM, an I/O, and a bus that connects these components, all of which are known. The HCU 1 executes various pieces of processing such as display control-related processing of generating a display image to be projected by using the HUD 4 and projecting the display image on the HUD 4 based on various pieces of information input from the periphery monitoring ECU 3, the vehicle state sensor group 5, the vehicle control ECU 6, the operation switch group 7, and the detection range correction unit 22. The HCU 1 corresponds to the vehicle display control device according to the claims.

Note that a part or all of the functions executed by the HCU 1 may be configured as hardware by one or a plurality of ICs and the like.

### Detailed Configuration of HCU 1

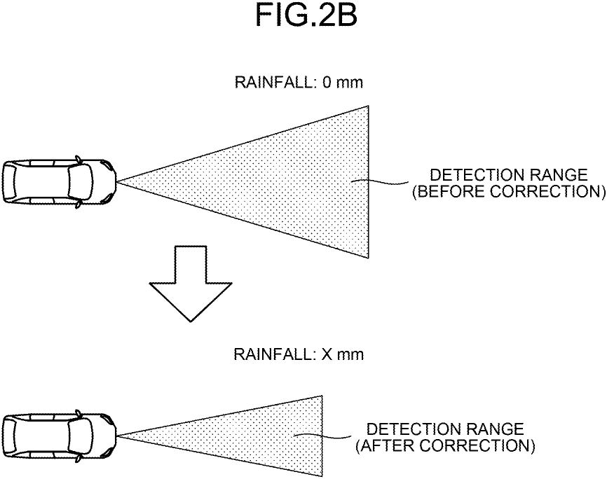

As illustrated in FIG. 3, the HCU 1 includes a sensor actuation detector 11, an automatic driving determination unit 12, a vehicle speed identification unit 13, a relative position identification unit 14, a relative speed identification unit 15, a detection indication region selection unit 16, a pre-conversion setting unit 17, a projection conversion unit 18, and a display control unit 19.

When the periphery monitoring ECU 3 is operating the obstacle sensor group 2, the sensor actuation detector 11 detects that the obstacle sensor group 2 is operating from a signal from the periphery monitoring ECU 3.

When the vehicle control ECU 6 performs follow-up traveling control or lane keeping control, the automatic driving determination unit 12 determines that the own vehicle is in automatic driving from a signal from the vehicle control ECU 6. In contrast, when the vehicle control ECU 6 does not perform either the follow-up traveling control or the lane keeping control, the own vehicle is determined to be in non-automatic driving.

The automatic driving determination unit 12 may determine whether the own vehicle is in the automatic driving or the non-automatic driving by on/off of a switch for switching start/end of automatic driving included in the operation switch group 7.

The vehicle speed identification unit 13 identifies the speed of the own vehicle from a signal from the vehicle speed sensor of the vehicle state sensor group 5. The relative position identification unit 14 identifies the relative position of an obstacle detected by the periphery monitoring ECU 3 with respect to the own vehicle as the relative position of the obstacle with respect to the own vehicle. That is, when the obstacle sensor group 2 detects an obstacle, the relative position identification unit 14 identifies the relative position of the obstacle with respect to the own vehicle. The relative speed identification unit 15 identifies the relative speed of an obstacle detected by the periphery monitoring ECU 3 with respect to the own vehicle as the relative speed of the obstacle with respect to the own vehicle.

The detection indication region selection unit 16 selects a range of personal safety space (hereinafter, detection indication region) based on an input operation of the driver to the operation switch group 7. The detection indication region is a region which the driver desires to grasp that the region is a detection region of the obstacle sensor group 2. Specifically, the detection indication region falls within the detection range of the obstacle sensor group 2, and extends from the own vehicle to the periphery along a road surface.

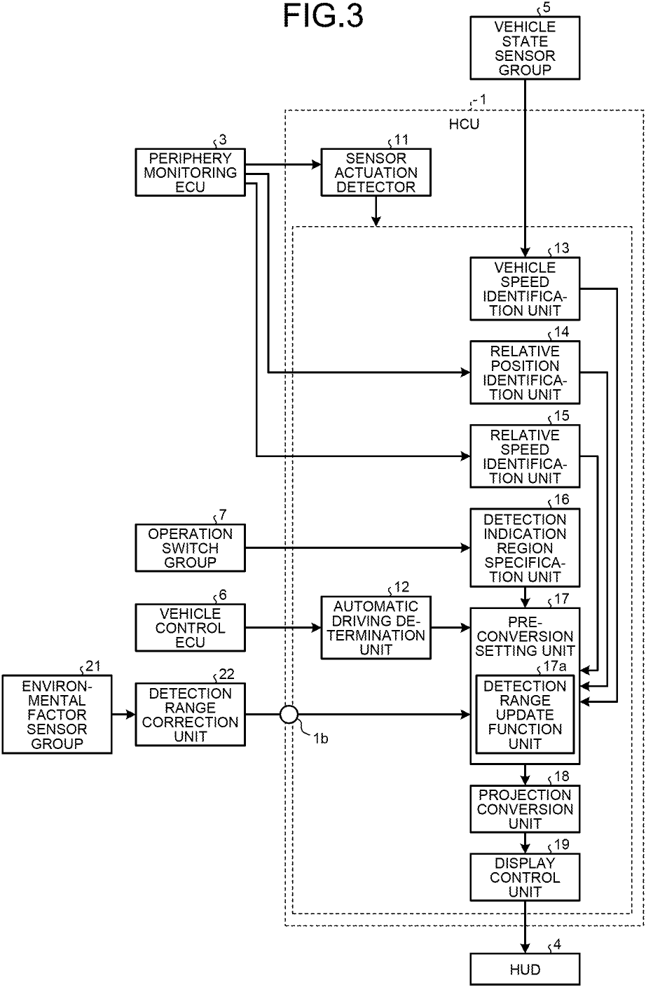

First, the detection indication region will be described with reference to FIG. 4. The detection indication region (see PSS in FIG. 4) is not the detection range itself (SE in FIG. 4) of the obstacle sensor group 2, but a region narrower than the detection range of the obstacle sensor group 2. The detection indication region is not intended to indicate the detection range itself of the obstacle sensor group 2, but is intended for the driver to grasp at least to what extent the range is to be detected by the obstacle sensor group 2. Therefore, the driver may freely select the range of the detection indication region as long as the range falls within the detection range of the obstacle sensor group 2.

Furthermore, the detection indication region is a flat region extending from the own vehicle to the periphery. In the present embodiment, as one example, it is a flat region horizontally extending from the own vehicle in a case where the own vehicle is located on a horizontal plane. The flat region has a shape that is longer in a front and rear direction of the own vehicle than in a direction of the width of the own vehicle and that extends along a lane.

For example, the detection indication region is expressed as a plane having a fixed height value on a world coordinate system in which the front and rear direction is defined as a Y-axis, a right and left direction is defined as an X-axis, and a height direction is defined as a Z-axis when viewed from the own vehicle. The detection indication region is set to have a Z-axis value that is not too far from the road surface when the height of the road surface is 0. In one example, the detection indication region may have a Z-axis value of approximately 1 m or less.

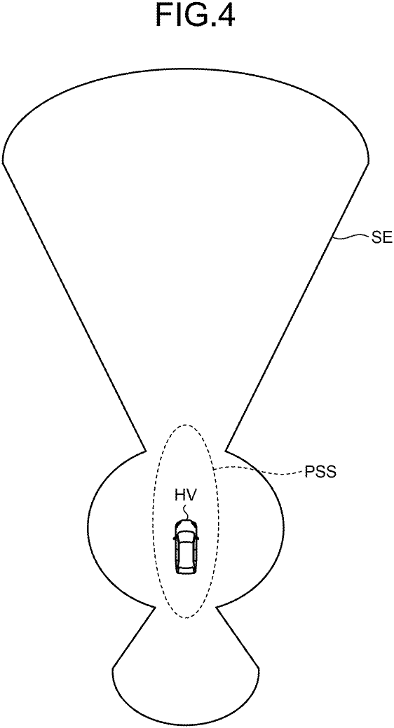

Subsequently, selection of the detection indication region will be described with reference to FIG. 5. Here, a case where three types of large, medium, and small of detection indication regions can be selected will be described as an example. In FIG. 5, PSS1 represents a detection indication region of a range “large”. PSSm represents a detection indication region of a range “medium”. PSSs represents a detection indication region of a range “small”.

The driver selects a preferred range from “large”, “medium”, and “small” by operating the operation switch group 7. The detection indication region selection unit 16 selects a detection indication region in a range selected by the input operation of the driver to the operation switch group 7 as a default detection indication region used for subsequent pieces of processing. The selected detection indication region is stored in, for example, a nonvolatile memory of the HCU 1, and kept until a new selection is made. The detection indication region selection unit 16 corresponds to a selection unit according to the claims.

The pre-conversion setting unit 17, the projection conversion unit 18, and the display control unit 19 will be described in detail in the following description of the display control-related processing.

### Display Control-Related Processing

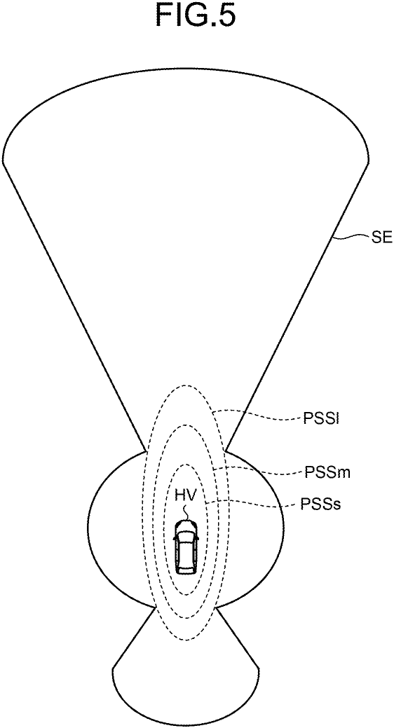

Here, the display control-related processing in the HCU 1 will be described with reference to a flowchart of FIG. 6. The flowchart of FIG. 6 starts when the sensor actuation detector 11 detects that the obstacle sensor group 2 is actuated. Here, for convenience, the description will be given on the assumption that the selection of a detection indication region has already been completed.

First, in Step S0, a detection range update function unit 17a of the pre-conversion setting unit 17 updates the default detection indication region selected by the detection indication region selection unit 16 in accordance with the detection range of the obstacle sensor group 2 corrected by the detection range correction unit 22. Although, in the present embodiment, the detection range update function unit 17a receives the detection range of the obstacle sensor group 2 corrected by the detection range correction unit 22 via an input port 1b of the HCU 1, this is not a limitation. For example, when the detection range correction unit 22 is provided in the HCU 1, the detection range update function unit 17a updates the detection indication region in accordance with the detection range of the obstacle sensor group 2 corrected by the detection range correction unit 22 in the HCU 1.

Next, in Step S1, the pre-conversion setting unit 17 determines the range of the detection indication region in accordance with the speed of the own vehicle identified by the vehicle speed identification unit 13 based on the range of the detection indication region updated by the detection range update function unit 17a.

Specifically, as the speed of the own vehicle becomes larger than a reference value, the default detection indication region is expanded within a range not exceeding the detection range of the obstacle sensor group 2. In contrast, as the speed of the own vehicle becomes smaller than another reference value, the default detection indication region is narrowed. Therefore, the detection indication region expands as the speed of the own vehicle increases, whereas the detection indication region narrows as the speed of the own vehicle decreases due to congestion and the like.

Note that, in S1, the detection indication region is not required to be changed from the default until the speed of the own vehicle exceeds upper and lower limit thresholds. When the speed exceeds the thresholds, the detection indication region may be expanded or narrowed in accordance with the speed of the own vehicle.

When the automatic driving determination unit 12 determines that the own vehicle is in automatic driving in Step S2 (YES in S2), Step S3 is taken. In contrast, when the automatic driving determination unit 12 determines that the own vehicle is in non-automatic driving (NO in S2), Step S10 is taken.

In Step S3, the pre-conversion setting unit 17 makes a setting for displaying the detection indication region determined in S1 in blue. In a specific example, RGB values are set for each coordinate of the detection indication region such that the blue color becomes lighter from the center to the edge of the detection indication region. That is, a setting is made such that a blurred edge is displayed.

When, in Step S4, the relative position of an obstacle with respect to the own vehicle identified by the relative position identification unit 14 is within the range of the detection indication region determined in S1 (YES in S4), Step S5 is taken. In contrast, when it is not within the range of the detection indication region (NO in S4), Step S8 is taken.

In Step S5, the pre-conversion setting unit 17 makes a setting for changing the display mode of the detection indication region in accordance with the relative position of the obstacle with respect to the own vehicle. First, an obstacle notification region for giving a notification of the presence of an obstacle is set in a boundary region in a direction corresponding to the relative position of the obstacle of the detection indication region.

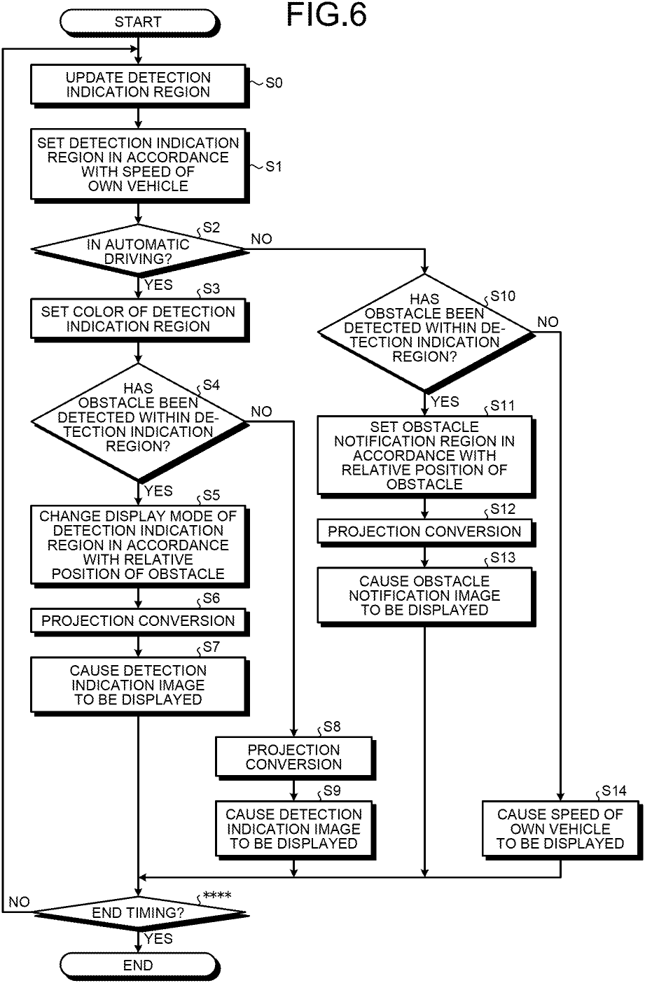

One example of the setting of the obstacle notification region will be described with reference to FIG. 7. In FIG. 7, HV represents the own vehicle. HVposi represents the position of the own vehicle. OVposi represents the position of an obstacle. PSS represents the obstacle notification region, and preAT represents a predetermined range centered on the position of the obstacle. AT represents the obstacle notification region.

When the obstacle notification region is set, the predetermined range (see preAT in FIG. 7) centered on the position of the obstacle (see OVposi in FIG. 7) is set for the detection indication region (see PSS in FIG. 7) determined in S1. The predetermined range is an elliptical or circular flat region centered on the position of the obstacle on the same plane as the detection indication region, and is smaller than the detection indication region. Then, a region where the predetermined range centered on the position of the obstacle overlaps the detection indication region is set as the obstacle notification region (see AT in FIG. 7).

As the position of the obstacle is made closer to the own vehicle, the region where the predetermined range centered on the position of the obstacle overlaps the detection indication region increases. Thus, as the relative position of the obstacle is made closer to the own vehicle, the range of the obstacle notification region is set larger.

Furthermore, when the obstacle notification region is set, RGB values are set for each coordinate of the obstacle notification region such that the yellow color becomes lighter from the position of the obstacle to the edge of the obstacle notification region. That is, a setting is made such that a blurred edge is displayed.

Moreover, the pre-conversion setting unit 17 makes a setting for displaying, in the obstacle notification region, an arc-shaped ripple spreading from the direction in which the obstacle is located. In a specific example, RGB values are set for each coordinate of the obstacle notification region such that the arc-shaped ripple spreading from the direction in which the obstacle is located has a color standing out in the obstacle notification region (e.g., orange).

In the present embodiment, four waves of the arc-shaped ripple are set in one example. When a setting for displaying the arc-shaped ripple is made, the distance between waves of the arc-shaped ripple (i.e., distance of ripple) is set so as to increase in a ripple spreading direction.

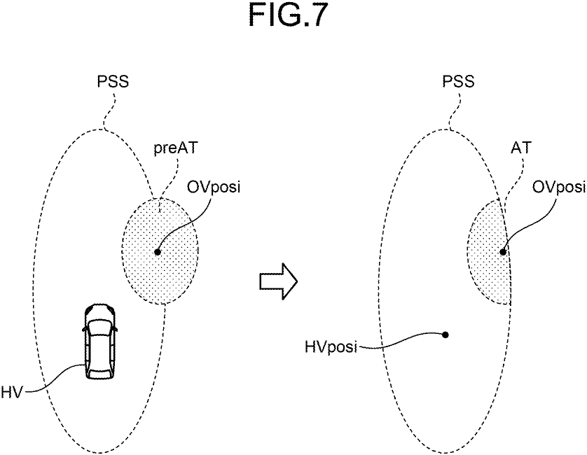

Furthermore, when the setting for displaying the arc-shaped ripple is made, the distance of the ripple is set so as to be narrowed as the relative speed of the obstacle with respect to the own vehicle increases as illustrated in one example in FIG. 8. FIG. 8 illustrates the distance of the ripple in comparison between a case where the obstacle has a larger relative speed and a case where the obstacle has a smaller relative speed.

Setting the distance of the ripple such that the distance is narrowed as the relative speed of the obstacle with respect to the own vehicle increases allows the driver to grasp the magnitude of the relative speed of the obstacle with respect to the own vehicle based on the degree of narrowing of the distance between waves of the arc-shaped ripple.

Furthermore, when the setting for displaying the arc-shaped ripple is made, patterns having different numbers of waves are set to display the ripple such that the arc-shaped ripple appears to move in the ripple spreading direction. That is, the obstacle notification region and the detection indication region including the arc-shaped ripple are set by the number of patterns having different numbers of waves.

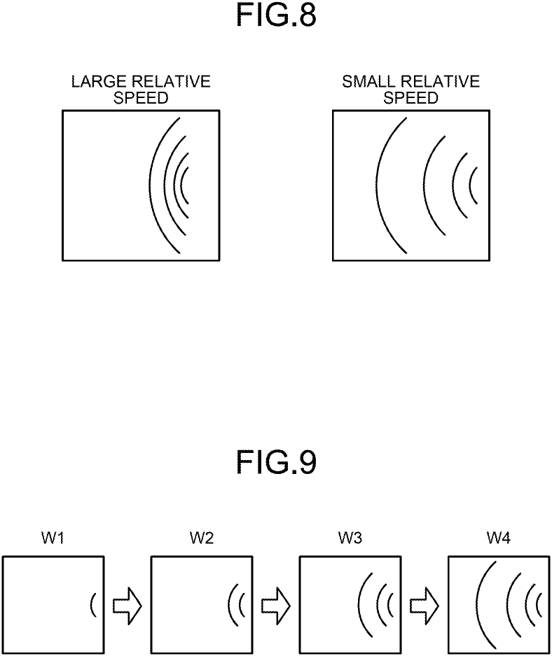

Here, setting of patterns having different numbers of waves will be described with reference to FIG. 9. In the example of the present embodiment, four waves are set. Thus, four patterns of “one” wave, “two” waves, “three” waves, and “four” waves as indicated in W1 to W4 are set as the patterns having different numbers of waves.

In Step S6, a region in front of the own vehicle is cut out from the detection indication region including the obstacle notification region set by the pre-conversion setting unit 17 in S5, and the projection conversion unit 18 converts the cut-out detection indication region into an image (hereinafter, detection indication image) viewed from the driver of the own vehicle by known projection conversion. The detection indication region to be cut out can also be rephrased as a range corresponding to a projection surface on the windshield on which the HUD image is projected. That is, the projection conversion unit 18 converts the detection indication region into the detection indication image representing the detection indication region from the viewpoint of the driver of the own vehicle. Note that the position of the viewpoint of the driver used for the projection conversion may be a preliminarily stored fixed position or a position detected by an occupant camera and the like.

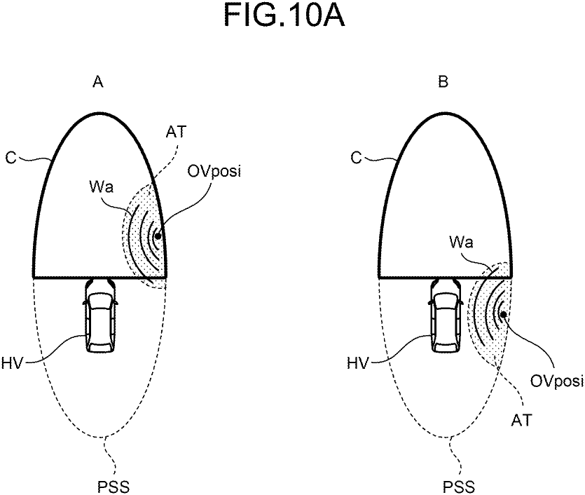

Here, one example of the detection indication region cut out in S6 will be described with reference to FIG. 10A. A of FIG. 10A is an example of a case where an obstacle is located diagonally right in front of the own vehicle. B is an example of a case where an obstacle is located on the right side of the own vehicle. In FIG. 10A, HV represents the own vehicle. OVposi represents the position of the obstacle. PSS represents the obstacle notification region. AT represents the obstacle notification region. Wa represents the arc-shaped ripple. C represents the detection indication region to be cut out.

When the obstacle is located within the detection indication region to be cut out and major parts of the obstacle notification region and the arc-shaped ripple are included within the range of the detection indication region to be cut out as illustrated in A of FIG. 10A, the major parts are also cut out. Then, the major parts of the obstacle notification region and the arc-shaped ripple are subjected to the projection conversion, and included in the detection indication image.

In contrast, when the obstacle is not located within the detection indication region to be cut out and the major parts of the obstacle notification region and the arc-shaped ripple are not included within the range of the detection indication region to be cut as illustrated in B of FIG. 10A, the major parts are not cut out. The obstacle notification region and the arc-shaped ripple which have not been cut out are not subjected to the projection conversion, and not included in the detection indication image.

Furthermore, the projection conversion on the cut-out detection indication region is performed by the number of patterns having different numbers of arc-shaped ripples.

In Step S7, the display control unit 19 performs processing of imparting a sense of transparency to the detection indication image subjected to the projection conversion by the projection conversion unit 18 in S6, transmits the detection indication image to the HUD 4, and instructs the HUD 4 to display the detection indication image. The projection conversion unit 18 and the display control unit 19 correspond to the display control unit according to the claims. The detection indication image obtained in S6 is projected on the windshield of the own vehicle by the HUD 4, so that the detection indication image is translucently superimposed and displayed on a scene visible to the driver of the vehicle. The processing of imparting a sense of transparency includes known alpha blending. That is, the display control unit 19 functions as a display control unit that superimposes and displays the detection indication image on a scene around the own vehicle.

Here, one example of processing of displaying the detection indication image will be described with reference to FIG. 10B. FIG. 10B illustrates one example of the processing of displaying a detection indication image. The detection range of the obstacle sensor group 2 may change due to an environmental factor such as a disturbance. In this case, even if an obstacle such as a vehicle OV2 is located within a detection range PE-A of the obstacle sensor group 2 in the absence of disturbance, if the detection range of the obstacle sensor group 2 narrows to a detection range PE-B, there is a possibility that the driver of the own vehicle is not notified despite the fact that the vehicle OV2 around the own vehicle is located.

Specifically, when a detection indication region PSS-p falls within the detection range PE-B, the driver is notified of the obstacle, such as the vehicle OV2, in the detection indication region PSS-p. When the speed of the own vehicle increases and the detection indication region PSS-p exceeds the detection range PE-B, however, if the obstacle such as the vehicle OV2 is located outside the detection range PE-B and inside a detection indication region PPS-p, the driver is not notified of the vehicle OV2 within the detection indication region PSS-p. The driver cannot know whether or not the detection function of the obstacle sensor group 2 is effectively working, and may experience a growing anxiety.

Therefore, in the present embodiment, the detection range update function unit 17a updates the detection indication region PSS-p in accordance with a corrected detection range PE of the obstacle sensor group 2. This allows the driver to be correctly notified of the fact that the detection range PE of the obstacle sensor group 2 is narrowed by the environmental factor, and thus can reduce the anxiety of the driver.

Furthermore, the display control unit 19 instructs the HUD 4 to repeatedly display the detection indication image including the obstacle notification region and the arc-shaped ripple, which has been subjected to the projection conversion by the number of patterns having different numbers of waves, in ascending order of the number of waves. In a specific example, the HUD 4 is instructed to repeatedly display it in order of the patterns of W1, W2, W3, and W4 in FIG. 8. According to this configuration, the detection indication image projected on the windshield can be displayed such that the number of waves of the arc-shaped ripple increases in order toward the ripple spreading direction, so that the arc-shaped ripple appears to move in the ripple spreading direction. This causes the driver to easily grasp an obstacle approach direction.

Furthermore, the display control unit 19 superimposes an image indicating the speed of the own vehicle on the detection indication image, and transmits the resulting image to the HUD 4 to project the speed of the own vehicle on the windshield together with the detection indication image. Note that the same applies to subsequent S9, S13, and S14. A value identified by the vehicle speed identification unit 13 is used for the speed of the own vehicle.

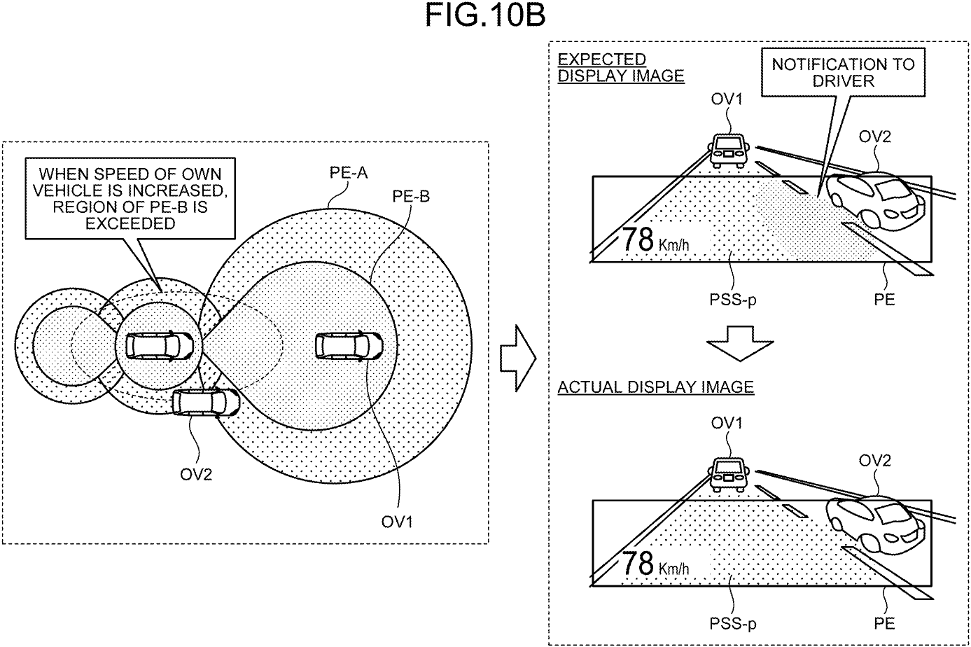

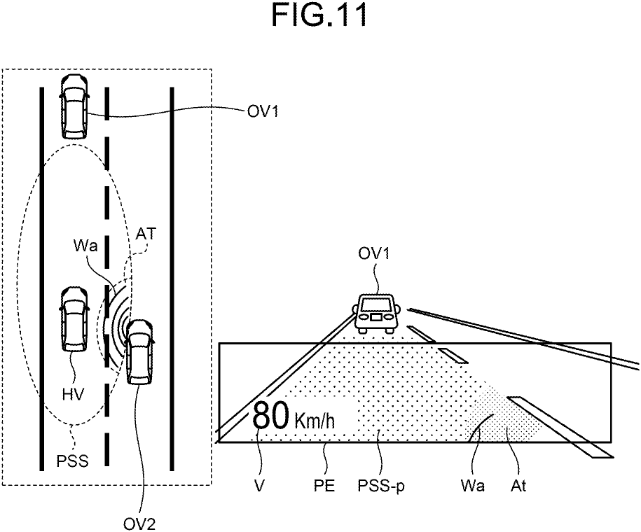

Here, a display mode of the detection indication image projected on the windshield by the HUD 4 in the processing of S7 will be described with reference to FIGS. 11 and 12. FIGS. 11 and 12 are schematic diagrams illustrating a scene in front of the own vehicle as viewed from the driver. FIG. 11 illustrates a case where a passing vehicle is located on the right side of the own vehicle. FIG. 12 illustrates a case where the passing vehicle is located diagonally right in front of the own vehicle.

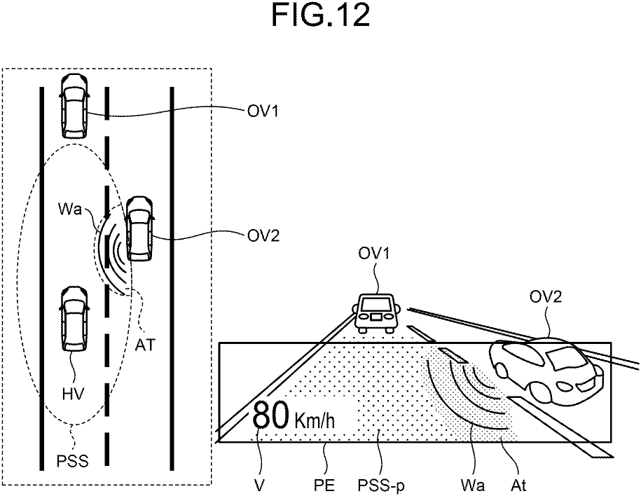

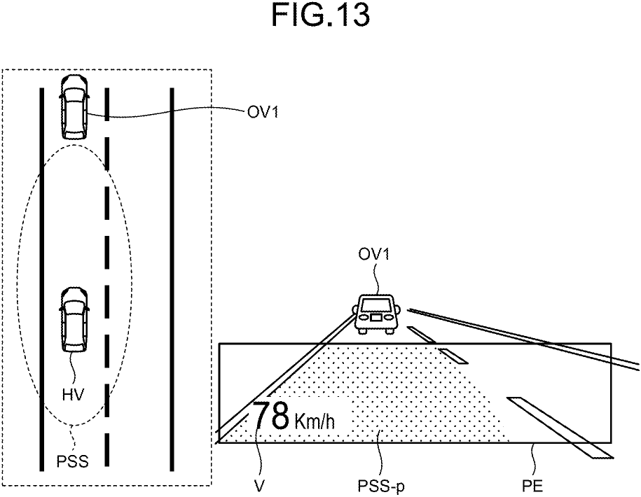

In FIGS. 11 and 12, for reference, the situation of the own vehicle viewed from a zenith direction is illustrated in a portion surrounded by a broken line. In FIGS. 11 and 12, OV1 represents a preceding vehicle. OV2 represents a passing vehicle that passes the own vehicle. PSS represents the detection indication region. V represents the speed of the own vehicle. PE represents a projection surface on which the detection indication image is projected. PSS-p represents the detection indication image obtained by performing the projection conversion on the detection indication region. At represents the obstacle notification region. Wa represents the arc-shaped ripple. Note that the same applies to overlapping reference signs also in subsequent FIGS. 13 and 14.

The detection indication region is a flat region horizontally extending from the own vehicle in a case where the own vehicle is located in the horizontal plane. When the own vehicle is located on a road surface, the detection indication region thus corresponds to the flat region extending along the road surface. Therefore, the detection indication image obtained by performing the projection conversion on the detection indication region, which is the flat region extending along the road surface, appears to extend along the road surface as illustrated in FIGS. 11 and 12.

When an obstacle is located within the detection indication region and even a part of the obstacle notification region is included in the detection indication image, as illustrated in FIGS. 11 and 12, a region corresponding to the above-described obstacle notification region in the detection indication image is displayed in yellow, and an arc-shaped ripple spreading from a direction in which the obstacle approaches is displayed in the region.

As illustrated in FIG. 11, even when the relative position of the passing vehicle serving as an obstacle with respect to the own vehicle is the right side of the own vehicle and the passing vehicle is not included in the front scene, the obstacle notification region and a part of the arc-shaped ripple are displayed so as to be superimposed on the front scene. Furthermore, the arc-shaped ripple is displayed so as to appear to spread from the direction in which the obstacle is located. This allows the driver to know that the passing vehicle is approaching from the right of the own vehicle even when the passing vehicle is not included in the front scene.

Furthermore, as illustrated in FIG. 12, when the relative position of the passing vehicle serving as an obstacle with respect to the own vehicle is the diagonally right in front of the own vehicle and the passing vehicle is included in a view field in front of the driver, the obstacle notification region and a major part of the arc-shaped ripple are displayed so as to be superimposed on the front scene. Furthermore, the arc-shaped ripple is displayed so as to appear to spread from the direction in which the obstacle is located. This allows the driver to confirm that the obstacle sensor group 2 can detect the passing vehicle included in the front scene. Note that, after S7, Step S15 is taken.

Returning to FIG. 6, in Step S8 in a case where the relative position of the obstacle with respect to the own vehicle identified by the relative position identification unit 14 is not within the range of the detection indication region determined in S1, the projection conversion unit 18 performs projection conversion of the detection indication region set by the pre-conversion setting unit 17 in S3 into a projection image (detection indication image) as in S6.

In Step S9, the display control unit 19 transmits the projection image subjected to the projection conversion by the projection conversion unit 18 in S8 to the HUD 4, and instructs the HUD 4 to display the projection image. The obstacle notification region and the arc-shaped ripple described above are not set in the detection indication region subjected to the projection conversion in S8, so that the detection indication image projected by the HUD 4 on the windshield does not have the obstacle notification region and the arc-shaped ripple described above.

Here, a display mode of the detection indication image projected on the windshield by the HUD 4 in the processing of S9 will be described with reference to FIG. 13. In the example in FIG. 13, no obstacle is detected. Thus, as illustrated in FIG. 13, a detection indication image without a change of color indicating the obstacle notification region and the arc-shaped ripple is displayed.

Returning to FIG. 6, in Step S10 in a case where the own vehicle is determined to be in the non-automatic driving, when the relative position of an obstacle with respect to the own vehicle identified by the relative position identification unit 14 is within the range of the detection indication region determined in S1 (YES in S10), Step S11 is taken. In contrast, when it is not within the range of the detection indication region (NO in S10), Step S14 is taken.

In Step S11, the pre-conversion setting unit 17 makes a setting of the obstacle notification region for giving notification about the presence of the obstacle as in S5 in accordance with the relative position of the obstacle with respect to the own vehicle. Also in S11, a setting is made for displaying the obstacle notification region in yellow.

In Step S12, the projection conversion unit 18 converts the obstacle notification region set by the pre-conversion setting unit 17 in S11 into an image viewed from the driver of the own vehicle by known projection conversion. Hereinafter, an image obtained by performing projection conversion on the obstacle notification region is referred to as an obstacle notification image. Although, in S12, a configuration in which the detection indication region is also subjected to the projection conversion together with the obstacle notification region may be adopted, the detection indication region other than the region corresponding to the obstacle notification region is not colored in the image since a setting for coloring and displaying the detection indication region is not made in the previous step. That is, the detection indication region other than the region corresponding to the obstacle notification region is not displayed in the image.

In Step S13, the display control unit 19 transmits the obstacle notification image subjected to the projection conversion by the projection conversion unit 18 in S12 to the HUD 4, and instructs the HUD 4 to display the obstacle notification image. An instruction is given to display the arc-shaped ripple in the obstacle notification image as described in S7.

Here, a display mode of the obstacle notification image projected on the windshield by the HUD 4 in the processing of S13 will be described with reference to FIG. 14. In the example in FIG. 14, the obstacle is located in the detection indication region, and a part of the obstacle notification region is located in front of the own vehicle. Therefore, the obstacle notification image in yellow is displayed, and, as illustrated in FIG. 14, the arc-shaped ripple spreading from the direction in which the obstacle approaches is displayed in the region of the obstacle notification image. Note that, the detection indication region other than the region corresponding to the obstacle notification region is not displayed.

In Step S14, the display control unit 19 transmits an image indicating the speed of the own vehicle to the HUD 4, and causes the speed of the own vehicle to be projected on the windshield. That is, when there is no obstacle during non-automatic driving, neither the detection indication image nor the obstacle notification image is projected on the windshield. After S14, Step S15 is taken.

In Step S15, when it is end timing of the display control-related processing (YES in Step S15), the display control-related processing is ended. In contrast, when it is not the end timing of the display control-related processing (NO in Step S15), it returns to S1 and is repeated. One example of the end timing of the display control-related processing is when the sensor actuation detector 11 no longer detects the actuation of the obstacle sensor group 2.

Although not described in detail in the present embodiment, when the relative position of the obstacle with respect to the own vehicle identified by the relative position identification unit 14 falls within the range of the detection indication region determined in S1 and is behind the own vehicle, the HCU 1 may generate an icon image for announcing that the obstacle is located behind the own vehicle. In this case, the generated icon image may be transmitted to the HUD 4, and displayed so as to be superimposed on the detection indication image and the obstacle notification image. That is, when the obstacle is within the detection indication region, the display control unit 19 changes the display mode of a boundary region in the direction corresponding to the relative position in the detection indication image.

### Summary of First Embodiment

The detection indication image is obtained by performing projection conversion of the detection indication region falling within the range to be detected by the obstacle sensor group 2 into an image viewed from the driver of the vehicle, so that at least to what extent the range is to be detected by the obstacle sensor group 2 can be expressed from the viewpoint of the driver. Furthermore, the detection indication region is a flat region extending along the road surface. Thus, as described above, the detection indication image obtained by performing projection conversion of the detection indication region into the image viewed from the driver of the vehicle appears to extend along the road surface from the driver when displayed so as to be superimposed on a scene viewed by the driver of the vehicle through the windshield of the vehicle.

In the first embodiment, the detection indication image is displayed when the obstacle sensor group 2 is detected to be actuated. Thus, the extension of the detection indication image along the road surface can represent at least to what extent the range is to be actually detected by the obstacle sensor group 2. When the detection indication image is represented along the road surface, it is easy to measure a sense of distance by using a structure and the like in contact with the road surface as a comparison target. Thus, the driver can easily grasp the sense of distance from the own vehicle intuitively. Therefore, the driver can intuitively grasp at least to what extent the range is to be actually detected by the obstacle sensor group 2.

Furthermore, it is considered that the driver particularly wants to grasp at least to what extent the range is to be detected by the obstacle sensor group 2 to get a sense of security during automatic driving compared with during non-automatic driving because the driver does not perform driving operation. According to the first embodiment, the display control unit 19 does not display the above-described detection indication image while the own vehicle is in non-automatic driving. In contrast, the display control unit 19 displays the above-described detection indication image when the own vehicle is in automatic driving. Thus, the display control unit 19 can display the detection indication image in a situation in which the driver is considered to particularly need the detection indication image.

In addition, according to the configuration of the first embodiment, the detection indication region is expanded as the speed of the own vehicle increases. It is considered that the driver has a demand for grasping a situation in front in a traveling direction earlier as the speed of the own vehicle increases. According to the above-described configuration, as the speed of the own vehicle increases, the detection indication region can be expanded in the traveling direction of the own vehicle. As a result, the demand can be satisfied.

Furthermore, according to the configuration of the first embodiment, the detection indication region is narrowed as the speed of the own vehicle decreases. Therefore, the detection indication region can be narrowed at the time of congestion. It is considered that preceding vehicles and vehicles traveling in parallel serving as obstacles are always located near the own vehicle at the time of congestion. The preceding vehicles and the vehicles traveling in parallel located nearby can be easily removed from targets announced as obstacles by narrowing the detection indication region at the time of congestion. As a result, at the time of congestion, display of an image indicating the obstacle notification region in relation to the preceding vehicles and the vehicles traveling in parallel located nearby can be inhibited to reduce trouble.

Furthermore, according to the configuration of the first embodiment, when the detection range of the obstacle sensor group 2 is narrowed by an environmental factor, the driver can be correctly notified of the fact that the detection indication region is narrowed by updating the detection indication region in accordance with the detection range of the obstacle sensor group 2 corrected based on the environmental factor, so that a sense of anxiety of the driver can be reduced.

### First Variation

Furthermore, there may be adopted a configuration in which time to collision (TTC) is calculated and a warning display or warning sound is output at the time when the TTC falls below a set value (hereinafter, first variation). TTC is a time period until the time at which it is predicted that the own vehicle and an obstacle run into each other. The first variation will be described below with reference to the drawings. Note that, for convenience of description, in the description of the first and subsequent variations, a member having the same function as the member in the drawings used for the description of the previous embodiment is denoted by the same reference sign, and the description thereof will be omitted.

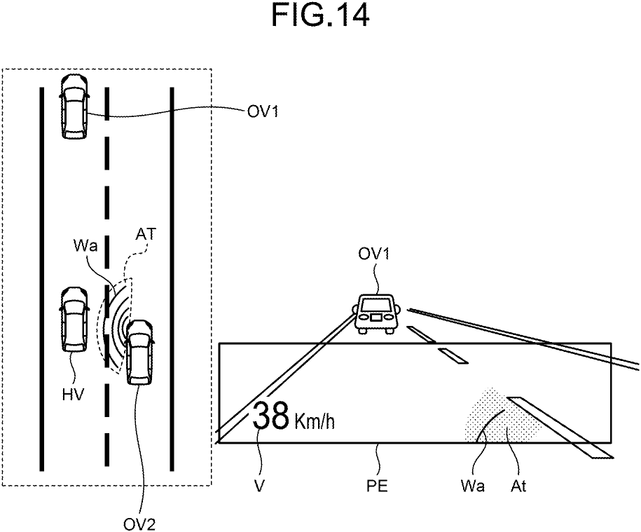

A driving assistance system 200 of the first variation is similar to the driving assistance system 100 of the first embodiment except that a turn signal switch 8 and a voice output device 9 are further included and that an HCU 1a is included instead of the HCU 1 as illustrated in FIG. 15.

The turn signal switch 8 detects a lamp lighting operation performed by a driver with a direction indicator (i.e., turn signal lamp lighting operation), and detects each of right and left turn signal lamp lighting operations. When the lamp lighting operation is performed, the turn signal switch 8 outputs a signal indicating which of right and left turn signal lamp lighting operations has been performed.

The voice output device 9 includes a speaker and the like, and outputs buzzer sound or voice in accordance with an instruction from the HCU 1a.

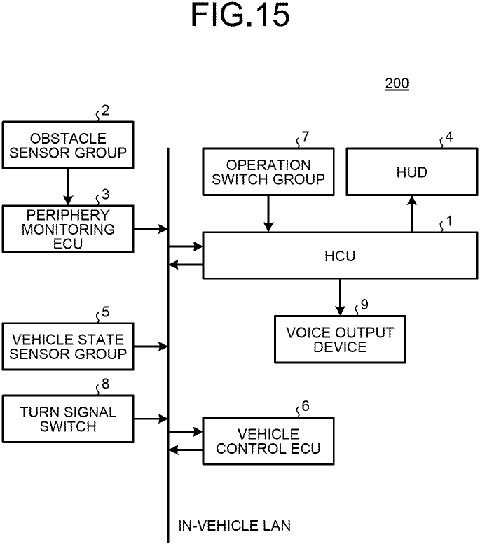

The HCU 1a includes the sensor actuation detector 11, the automatic driving determination unit 12, the vehicle speed identification unit 13, the relative position identification unit 14, the relative speed identification unit 15, the detection indication region selection unit 16, the pre-conversion setting unit 17, the projection conversion unit 18, the display control unit 19, and a TTC determination unit 20. That is, it is similar to the HCU 1 of the first embodiment except that the TTC determination unit 20 is provided. Processing in the TTC determination unit 20 will be described below with reference to FIG. 16. In FIG. 16, members of the HCU 1a other than members necessary for describing the processing in the TTC determination unit 20 are omitted.

When the relative position of an obstacle with respect to the own vehicle identified by the relative position identification unit 14 is within the range of the detection indication region, the TTC determination unit 20 calculates TTC based on the relative position of the obstacle with respect to the own vehicle identified by the relative position identification unit 14, the relative speed of the obstacle with respect to the own vehicle identified by the relative speed identification unit 15, and a signal from the turn signal switch 8.

In one example, whether or not the own vehicle and the obstacle are in the relation of running into each other is estimated from a temporal change in the relative position of the obstacle with respect to the own vehicle. Then, when they are estimated to be in the relation of running into each other, the TTC is calculated by dividing the distance from the current position to a point where the own vehicle and the obstacle run into each other by the relative speed of the obstacle with respect to the own vehicle.

Furthermore, when the own vehicle and the obstacle are not in the relation of running into each other, that is, when the obstacle is traveling in parallel in an own lane or a lane adjacent to the own lane or when the obstacle is traveling in a lane opposite to the own lane, TTC is calculated by setting the TTC as infinite.

Note, however, that, even when the own vehicle and the obstacle are not in the relation of running into each other, if a direction in which the obstacle changes a course thereof can be identified from a signal of the turn signal switch 8, whether or not the own vehicle and the obstacle are in the relation of running into each other is estimated again on the assumption that the own vehicle changes a course thereof in the identified direction. Then, when the own vehicle and the obstacle are estimated to be in the relation of running into each other, the TTC is calculated by dividing the distance from the current position to a point where the own vehicle and the obstacle run into each other by the relative speed of the obstacle with respect to the own vehicle.

Note that whether or not the own vehicle and the obstacle are in the relation of running into each other may be estimated by whether or not a predicted track of the own vehicle and a predicted track of the obstacle intersect with each other. The predicted track of the own vehicle is determined from a temporal change in the current position of the own vehicle detected by using a receiver used in a satellite positioning system. The predicted track of the obstacle is determined from a temporal change in the relative position of the obstacle with respect to the own vehicle.

When the TTC calculated as described above falls below a set value, the TTC determination unit 20 causes the voice output device 9 to output warning sound. Furthermore, when the TTC falls below the set value, the TTC determination unit 20 notifies the display control unit 19 that the TTC falls below the set value. The set value here can be set optionally, and is, for example, 3.2 sec.

When receiving notification that the TTC has fallen below the set value, the display control unit 19 superimposes an icon image indicating warning (hereinafter, warning icon image) and an icon image indicating a direction in which the own vehicle changes a course thereof (course icon image) on the detection indication image and the obstacle notification image, and transmits the resulting image to the HUD 4. As a result, the warning icon image and the course icon image are projected on the windshield together with the detection indication image and the obstacle notification image.

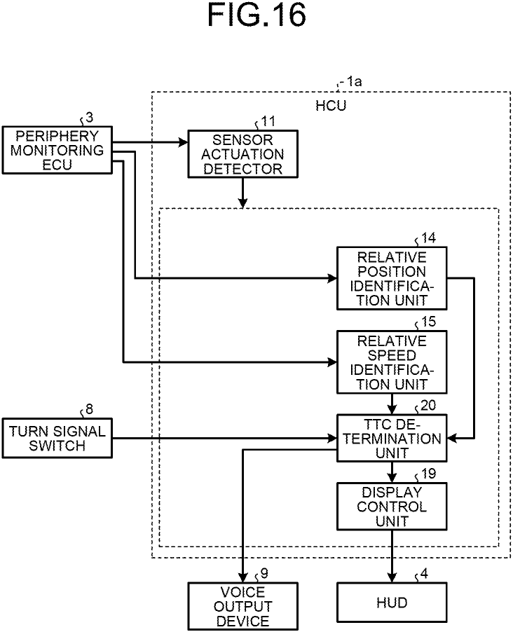

Here, one example of display of an icon image for warning about running into an obstacle will be described with reference to FIG. 17. FIG. 17 illustrates, in an example, a case where the own vehicle changes lanes to the adjacent right lane with an obstacle in automatic driving. D in FIG. 17 represents a warning icon image, and E represents a course icon image.

When a passing vehicle (OV2 in FIG. 17) is detected diagonally right in front of the own vehicle, a detection indication image including an obstacle notification region represented in yellow and an arc-shaped ripple are displayed. Here, when the own vehicle tries to change lanes to the adjacent right lane and the TTC with the passing vehicle falls below a set value, not only the obstacle notification region represented in yellow and the arc-shaped ripple but a warning icon image (D in FIG. 17) as illustrated in FIG. 17 are displayed to give notification about the risk of running into the passing vehicle. Furthermore, not only the warning icon image but the course icon image (E in FIG. 17) indicating a direction of course change are displayed.

Furthermore, when the own vehicle is not trying to change lanes to the adjacent right lane, the TTC with the passing vehicle does not fall below the set value. Therefore, the obstacle notification region represented in yellow and the arc-shaped ripple are displayed, but warning sound is not output and a warning icon image is not displayed.

As described above, according to the first variation, only when remaining time until the own vehicle and the obstacle are estimated to run into each other falls below the set value, the warning sound is output and the warning icon image is displayed in addition to the obstacle notification region represented in yellow and the arc-shaped ripple. Therefore, only when there is a risk of running into the obstacle, special warning such as output of the warning sound and display of the warning icon image is given, which can cause the driver to be aware of the risk of running into the obstacle.

Note that, although FIG. 17 illustrates an example in a case where the own vehicle changes lanes, it is needless to say that the example can be applied not only to a case of lane exchange but to a case of turning to the right/left at an intersection. Furthermore, a configuration in which the direction in which the own vehicle changes a course thereof is identified from a signal from the turn signal switch 8 has been described, but, when a switch, other than the turn signal switch 8, for the driver to indicate the direction in which the own vehicle changes the course thereof is provided in the own vehicle, the direction in which the own vehicle changes the course thereof may be identified from a signal from the switch.

### Second Variation

Although, in the above-described embodiment, a configuration in which, when the own vehicle is in non-automatic driving, a blue detection indication image is not displayed even when the obstacle sensor group 2 is in actuation has been described, this is not necessarily a limitation. For example, even when the own vehicle is in non-automatic driving, if the obstacle sensor group 2 is in actuation, the blue detection indication image may be displayed as in the case of automatic driving.

### Third Variation

Furthermore, when the obstacle detected by the periphery monitoring ECU 3 is identified to be located at a lane opposite to the own vehicle, the obstacle notification region and the arc-shaped ripple are not preferably displayed for the obstacle located in the lane opposite to the own vehicle.

In one example, the fact that the obstacle is located in the lane opposite to the own vehicle may be identified by detecting a center line by recognizing an image captured by a camera that images a road surface in front of the own vehicle and considering that the obstacle is located on the opposite side of the own lane across the center line. In this case, the obstacle sensor group 2 includes the camera that images a road surface in front of the own vehicle. Note that it goes without saying that another method may be used when the obstacle located in the lane opposite to the own vehicle can be identified by the other method.

According to the third variation, the obstacle notification region and the arc-shaped ripple are not required to be displayed for an oncoming vehicle located in the lane opposite to the own vehicle, which avoids troubles caused by the obstacle notification region and the arc-shaped ripple being displayed each time the oncoming vehicle and the own vehicle run into each other.

### Fourth Variation

Although, in the above-described embodiment, the obstacle notification region is displayed in yellow, and the detection indication region excluding the obstacle notification region is displayed in blue, this is not necessarily a limitation. For example, the obstacle notification region and the detection indication region excluding he obstacle notification region may be displayed in other colors as long as the colors are different. When different colors are used, not only a configuration in which different hues such as yellow and blue are used but a configuration in which different saturations and brightnesses are used may be adopted among color attributes.

### Fifth Variation

Furthermore, the luminance and color of an image projected on the windshield may be changed in accordance with an environment around the own vehicle. In one example, at night, the luminance and brightness of the image are lowered to increase visibility. In another example, on a snowy road, the luminance and the brightness are increased, and the color of the detection indication region is changed from blue to green to increase visibility. The fact that it is at night may be identified by using time or an illuminance sensor. The fact that it is a snowy road may be identified by recognizing an image obtained by imaging a road surface with a camera and detecting white color spreading over the road surface.

### Sixth Variation

Furthermore, when obstacles are frequently detected in a certain direction such as a left side or a right side as viewed from the own vehicle as in a case where the own vehicle is frequently passed by passing vehicles, the each-time display of the obstacle notification image and the arc-shaped ripple may be stopped, and a fixed color different from the color of the detection indication image may be displayed in a wide range in the direction in which obstacles are frequently detected.

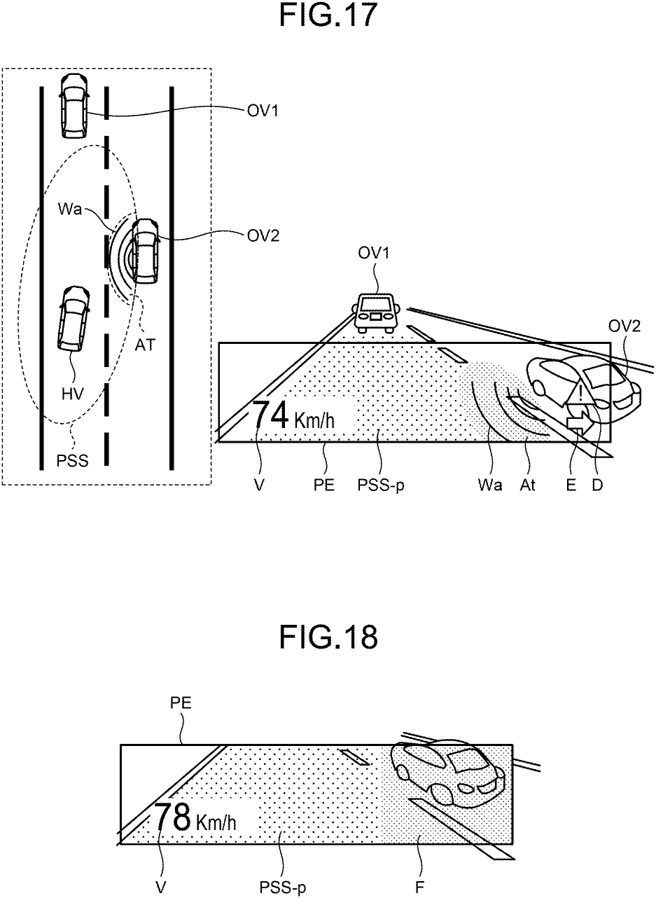

Whether or not obstacles are frequently detected may be determined from the number of detections of the obstacles per unit time. In one example, the fixed color may be translucent orange. Furthermore, when obstacles are frequently detected on the right side of the own vehicle, the fixed color may be displayed in a wide range in a right direction of a projection surface where the detection indication image is projected as illustrated in FIG. 18 (see F in FIG. 18). When obstacles are frequently detected in a left direction of the own vehicle, the fixed color may be displayed in a wide range in a left direction of the projection surface where the detection indication image is projected.

According to the sixth variation, troubles caused by frequent movements and frequent appearance and disappearance of the obstacle notification image and the arc-shaped ripple can be avoided.

### Seventh Variation

Although, in the above-described embodiment, the HCU 1 performs projection conversion to obtain the detection indication image and the obstacle notification image, this is not necessarily a limitation. For example, detection indication images and obstacle notification images of a plurality of patterns preliminarily subjected to projection conversion may be stored in the memory of the HCU 1 for each conditions such as the presence or absence of an obstacle, a direction of the obstacle with respect to the own vehicle, a relative speed of the obstacle with respect to the own vehicle, a speed of the own vehicle, and a range that can be selected by the detection indication region selection unit 16, and a detection indication image and an obstacle notification image matching the conditions may be read from the memory.

### Eighth Variation

Although, in the above-described embodiment, the HUD 4 superimposes and displays an image subjected to projection conversion by the HCU 1 on a scene visible to the driver of the own vehicle through the windshield of the own vehicle, this is not necessarily a limitation. For example, the image subjected to projection conversion by the HCU 1 may be superimposed and displayed on an image obtained by imaging the scene visible to the driver of the own vehicle, such as a scene in front of the own vehicle.

According to the eighth variation as well, at least to what extent a range is to be detected by the obstacle sensor can be displayed in a manner in which comparison with the scene visible to the driver of the own vehicle can be performed. Thus, the driver can intuitively grasp at least to what extent a range is to be detected by the obstacle sensor.

A program to be executed by the driving assistance system 100 of the present embodiment is provided by being preliminarily incorporated in a read only memory (ROM) or the like. The program to be executed by the driving assistance system 100 of the present embodiment may be provided by being recorded in a computer-readable recording medium such as a CD-ROM, a flexible disk (FD), a CD-R, and a digital versatile disk (DVD) in a file in an installable format or an executable format.

Moreover, the program to be executed by the driving assistance system 100 of the present embodiment may be provided by being stored in a computer connected to a network such as the Internet and downloaded via the network. Furthermore, the program to be executed by the driving assistance system 100 of the present embodiment may be provided or distributed via the network such as the Internet.

A vehicle display control system, a computer-readable medium, a vehicle display control method, and a vehicle display control device according to the present disclosure can reduce anxiety of a driver.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A vehicle display control system comprising:
an obstacle sensor that detects an obstacle around a vehicle;
an environmental factor sensor that detects an environmental factor that changes a detection range of the obstacle sensor with respect to the obstacle;
a memory; and
a hardware processor coupled to the memory,
the hardware processor being configured to:
control a display device that converts a detection indication region falling within the detection range of the obstacle sensor with respect to the obstacle, into a detection indication image representing the detection indication region from a viewpoint of a driver of the vehicle, and superimposes and displays the detection indication image on a scene around the vehicle;
correct the detection range in accordance with the environmental factor; and
update the detection indication region in accordance with the detection range that has been corrected.

2. The vehicle display control system according to claim 1, wherein
the environmental factor includes a disturbance that changes the detection range, and
the hardware processor is configured to narrow the detection range as the disturbance increases.

3. The vehicle display control system according to claim 2, wherein the disturbance includes at least one of rain, snow, fog, temperature, and sunlight.

4. The vehicle display control system according to claim 1, wherein the hardware processor is further configured to:
identify a relative position of the obstacle with respect to the vehicle in a case where the obstacle sensor detects the obstacle; and
change a display mode of a boundary region in a direction in accordance with the relative position, in the detection indication image when the obstacle is within the detection indication region.

5. The vehicle display control system according to claim 1, wherein
the vehicle allows to switch between automatic driving in which the vehicle automatically performs at least any of steering, and acceleration and deceleration, and non-automatic driving in which the vehicle performs both steering, and acceleration and deceleration in accordance with driving operation of the driver, and
the hardware processor is configured to display the detection indication image when the vehicle is in the automatic driving, and not to display the detection indication image when the vehicle is in the non-automatic driving.

6. A non-transitory computer-readable medium on which programmed instructions are stored, wherein the programmed instructions, when executed by a computer, cause the computer to function as:
a display control unit configured to control a display device that converts a detection indication region falling within a detection range of an obstacle sensor that detects an obstacle around a vehicle, into a detection indication image representing the detection indication region from a viewpoint of a driver of the vehicle, and superimposes and displays the detection indication image on a scene around the vehicle;
a detection range correction unit configured to correct the detection range in accordance with a detection result of an environmental factor that changes the detection range; and
a detection range update function unit configured to update the detection indication region in accordance with the detection range that has been corrected.

7. A vehicle display control method to be executed by the vehicle display control system according to claim 1, the method comprising:
controlling a display device that converts a detection indication region falling within a detection range of an obstacle sensor that detects an obstacle around a vehicle, into a detection indication image representing the detection indication region from a viewpoint of a driver of the vehicle, and superimposes and displays the detection indication image on a scene around the vehicle;
correcting the detection range in accordance with a detection result of an environmental factor that changes the detection range; and
updating the detection indication region in accordance with the detection range that has been corrected.

8. A vehicle display control device comprising:
a memory; and
a hardware processor coupled to the memory,
the hardware processor being configured to:
convert a detection indication region falling within a detection range of an obstacle sensor that detects an obstacle around a vehicle, into a detection indication image representing the detection indication region from a viewpoint of a driver of the vehicle, and superimposes and displays the detection indication image on a scene around the vehicle; and
update the detection indication region in accordance with the detection range that has been corrected based on a detection result of an environmental factor that changes the detection range.

9. The vehicle display control device according to claim 8, wherein the hardware processor is further configured to:
identify a relative position of the obstacle with respect to the vehicle in a case where the obstacle sensor detects the obstacle, and
change a display mode of a boundary region in a direction in accordance with the relative position, in the detection indication image when the obstacle is within the detection indication region.

10. The vehicle display control device according to claim 8, wherein
the vehicle allows to switch between automatic driving in which the vehicle automatically performs at least any of steering, and acceleration and deceleration and non-automatic driving in which the vehicle performs both steering, and acceleration and deceleration in accordance with driving operation of the driver, and
the hardware processor is configured to display the detection indication image when the vehicle is in the automatic driving, and configured not to display the detection indication image when the vehicle is in the non-automatic driving.
